(19) United States
(12) Patent Application Publication
(10) Pub. No.: US 2017/0048431 A1
(43) Pub. Date: Feb. 16, 2017

(54) VARIABLE OPTICAL ZOOM LENS DEVICE FOR PORTABLE ELECTRONIC DEVICES AND METHOD OF INTEGRATION

(71) Applicant: Weiyong YU, Shreveport, LA (US)

(72) Inventor: Weiyong YU, Shreveport, LA (US)

(73) Assignee: Board of Supervisors of Louisiana State University and Agricultural and Mechanical College, Baton Rouge, LA (US)

(21) Appl. No.: 15/198,687

(22) Filed: Jun. 30, 2016

Related U.S. Application Data
(60) Provisional application No. 62/203,420, filed on Aug. 11, 2015.

(51) Int. Cl. H04N 5/225; H04N 5/232; G03B 17/56; G02B 13/00; G02B 7/10

(52) U.S. Cl. CPC H04N 5/2254; G02B 13/009; G02B 7/10; G03B 17/565; H04N 5/23296

(57) ABSTRACT

An optical zoom lens device for use with a portable electronic device comprising an encasement including a lens and a light sensor and a pivot for connecting the encasement to the portable electronic device.

### CROSS REFERENCE TO RELATED APPLICATIONS/PRIORITY

The present invention claims priority to U.S. Provisional Patent Application No. 62/203,420, filed on Aug. 11, 2015, which is incorporated by reference into the present disclosure as if fully restated herein. To the extent that there is any conflict between the incorporated material and the present disclosure, the present disclosure will control.

### FIELD OF THE INVENTION

The present invention relates to the field of portable electronic devices (PEDs). The invention comprises the general design of integrating camera and video lens into PEDs.

### BACKGROUND OF THE INVENTION

Current portable electronic devices (“PEDs”) such as mobile/cell phones (like iPhone6®, a Samsung Galaxy S6®, or an HTC 10®, electronic document readers, tablet computers, laptops, personal digital assistants (“PDAs”), MP3 players, handheld game players, and similar electronics often have a camera function to take photos and videos. The quality of still photos may be comparable to conventional consumer cameras. But the quality and variation of videos, and especially the range of optical zoom, are still far from the consumer camcorders on the market. A major reason is the length of the lens structure of camcorders with variable optical zooms is usually much larger than the thickness of a PED, which makes it very challenging to embed such a large component into a thin device like a still PED camera lens. A video camera without variable enough high optical zoom, 10-20× for example, is at a disadvantage when attempting to take high quality videos with needed zoom changes. That is one reason why PEDs do not take comparable videos as consumer camcorders do. This also limits the capability to take quality still photos of far objects for PEDs.

### SUMMARY OF THE INVENTION

Wherefore, it is an object of the present invention to overcome the above mentioned shortcomings and drawbacks associated with the prior art.

The present invention relates to the designs of PEDs or their accessories for shooting videos and still photos with high quality lens and highly variable optical zooms. The invention comprises multiple designs of directly or indirectly integrating lens devices having variable optical zooms into PEDs. For direct integration, the variable optical zoom lens device is preferably attached to the back, the top or bottom, or the right or the left side of the PEDs. When shooting a video or a still photo, the optical zoom lens device turns or is turned to aim at the object. Many of the operation controls may be the substantially same as current camera functions on the PEDs, and new functionality may be controlled in a similar manner. For indirect integration, the optical zoom lens device may be fabricated as an accessary, which connects to the PEDs through, e.g., the data connector. In this case, the accessory optical zoom lens device can also be engineered into the plain covers/cases, underwater cases, external battery power cases, selfie sticks, or similar structures that protect, hold, and/or support the PEDs.

A first embodiment of the presently claimed invention includes methods and an optical zoom lens device for use with a portable electronic device comprising an encasement including a lens and a light sensor and a pivot for connecting the encasement to the portable electronic device.

Optional alternative embodiments include a length between the lens and the light sensor being adjustable. The encasement may be rotatable about the pivot. Electronic connections may be adjacent to the pivot for one of powering movement of a direction of aim of the lens, a change of zoom, a change of focus, and some combination thereof, and transmitting one of audio, visual, and control signals one of to and from the optical zoom lens device. One of the encasement and the pivot may include one of a microphone, a speaker, a light, and a light sensor. An electronic jack may be located on one of the encasement and the pivot. The jack may be one of a power connection, a data connection, an audio connection, a video connection, an audio and video connection, and some combination thereof

A further embodiment of the presently claimed invention includes methods a portable electronic device comprising a body, a screen; and an optical zoom lens device, where the optical zoom lens device includes an encasement including a lens and a light sensor, and a pivot for connecting the encasement to the portable electronic device.

Optional alternative embodiments include the body defining a recess or opening where the encasement may rest in a docked position, and from which the encasement may pivot in a deployed position. When the encasement is in the docked position, the encasement may be substantially flush with a thickness of the body. The optical zoom lens device may be directly integrated into the portable electronic device. The optical zoom lens device may be aligned along a perimeter of the body. The optical zoom lens device may be arranged on a side of the body opposite to the screen. A cross section of the encasement may be substantially equal to a thickness of the body. A length of the encasement may be substantially equal to one of a height and width of the body. The body may include enclosures that bound one or both axial ends of the encasement when the encasement is in a docked position. The pivot may include a plurality of hinges and a folding level.

A yet further embodiment of the presently claimed invention includes methods and a portable electronic device case comprising a casing and an optical zoom lens device located in the casing, where the optical zoom lens device includes an encasement including a lens and a light sensor, and a pivot for connecting the encasement to the portable electronic device.

Alternative optional embodiments include an electronic connection on the pivot to electronically connect the optical zoom lens device to a portable electronic device, and an electronic jack located on one of the encasement and the pivot. The jack may be one of a power connection, a data connection, an audio connection, a video connection, an audio and video connection, and some combination thereof.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore the claimed invention should not necessarily be construed as limited to addressing any of the particular problems or deficiencies discussed herein

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIGS. 1A-1C are schematic views showing a first embodiment of the structure of an optical zoom lens device according to the present invention directly integrated into a smartphone, with the front or screen side of the phone facing up out of the page of the figure; FIG. 1A shows the optical zoom lens device docked with the phone when not in use, in a resting status; FIG. 1B shows the optical zoom lens device of FIG. 1A rotating or turning to face an object for shooting videos or photos; FIG. 1C is a top-view of the optical zoom lens device of FIG. 1A, with a pivot structure in the center to connect the optical zoom lens device and the phone physically and/or electronically; electronic wires are not shown in the drawings for clarity;

FIG. 2A is a partial cutout view of the directly integrated optical zoom lens device of FIG. 1A showing a pivot structure; the pivot structure is enlarged for clarity; but it can be small or large;

FIG. 2B is an up-close view of the optical zoom lens device of FIG. 1A with an optional access port on the optical zoom lens device;

FIGS. 3A and 3B are schematic plan views of an optical zoom lens device according to the present invention directly integrated into a smartphone in off centered locations, in contrast to the centered placement shown in FIG. 1A; especially if the length of the optical zoom lens device is less than the width of the phone, multiple placement options become available, including locating the optical zoom lens device along the top of the smartphone in the middle as shown in FIG. 1A, skewed to the left as shown in FIG. 3B or skewed to the right as shown in FIG. 3C;

FIGS. 4A-4C are schematic plan views of an optical zoom lens device according to the present invention directly integrated into a smartphone on the bottom of the phone; especially if the length of the optical zoom lens device is less than the width of the phone, multiple placement options become available, including locating the optical zoom lens device along the bottom of the smartphone in the middle as shown in FIG. 4A, skewed to the left as shown in FIG. 4B, or skewed to the right as shown in FIG. 4C;

FIGS. 5A-5C are schematic plan views of an optical zoom lens device according to the present invention directly integrated into a smartphone on the side of the phone; especially if the length of the optical zoom lens device is less than the height of the phone, multiple placement options become available, including locating the optical zoom lens device along the middle as shown in FIG. 5A, skewed to the bottom as shown in FIG. 5B, or skewed to the top as shown in FIG. 5C;

FIGS. 6A and 6B are schematic plan views of an optical zoom lens device according to the present invention directly integrated into a smartphone on the back of the phone; multiple anticipated locations are shown including the vertical position in the middle of the back in FIG. 6A and skewed to the left of the back in FIG. 6B and in the horizontal position in the upper portion of the back in FIG. 6C; not shown are anticipated locations in the right side of the back in the vertical position, the middle and lower portions of the back in the horizontal position, and diagonally across the back from a top corner to a bottom corner or shorter and/or shifted up or down and/or left or right;

FIGS. 7A-7C are schematic side plan views of an optical zoom lens device according to the present invention directly integrated into a smartphone including an optional hinge/level support structure to pivot the optical zoom lens device and maintain a stable position with relation to the phone when aimed towards the object(s), the optical zoom lens device shown in a fully recessed position shown in 7A, a partially deployed position shown in 7B, and a fully deployed position shown in 7C;

FIG. 8 is a schematic plan view of an indirectly integrated optical zoom lens device where the optical zoom lens device is engineered into a cover/case, where the case/cover are attached to the phone and thus connect the optical zoom lens device to the phone; the contour represents the casing of a case with an recess to hold and protect the optical zoom lens device and to make the overall contour sleek; similarly, the optical zoom lens device may pop up through a pivot design; and

FIG. 9 is an example for an indirectly integrated stand-alone unit optical zoom lens device accessory connected to a smartphone directly through the smartphone data connector.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention

The present invention will be understood by reference to the following detailed description, which should be read in conjunction with the appended drawings. It is to be appreciated that the following detailed description of various embodiments is by way of example only and is not meant to limit, in any way, the scope of the present invention.

The optical zoom lens device 1 can be substantially any form/shapes, though a cylindrical shape is anticipated. The optical zoom lens device 1 may be formed from any materials, though glass, plastics, and metals are anticipated. A variable optical zoom is preferred, though stationary zoom is also anticipated, and digital zoom may be used in addition with appropriate software control. The optical zoom lens device 1 can be controlled electronically by manual control or automatically, or mechanically automatically or manually or both to change the optical zoom lens device 1 zoom factor and/or direction. Controlling parts may be partially or completely integrated into or attached to the optical zoom lens device 1 or separately placed in the PED 14 or the case of the PED 14, or may be controlled via one or more PED controllers 38 or via a user interface on the PED screen 15. The optical zoom lens device 1 may be a parfocal zoom or a varifocal zoom lens 18. The focus may be adjustable manually or automatically as needed. The lens 18 may be comprised of one or more lenses, preferably in a plurality of lens groups. The lens groups preferably move with respect to one another and the image or light sensor 8 to change the zoom and/or focus of an image passing through the lens groups and hitting the light sensor 8. The lenses 18 in the lens groups are preferably a combination of biconvex, planoconvex, positive meniscus, negative meniscus, planoconcave, and biconcave lenses 18 arranged preferably in between two and nine and more preferably three and seven groups to function as a zoom lens 18, as would be understood by one of ordinary skill in the art. The optical zoom lens device 1 may also have other functions and include other elements such as microphone, speaker, and/or a flash light, for example, integrated or attached to it.

A standard optical zoom lens is usually much longer in size compared to the thickness 20 of a portable electronic device 14 (“PED”). A typically thin PED 14 is a smartphone, and so this embodiment of PEDs 14 will be used to demonstrate the invention. In order to integrate a relatively long optical zoom lens device 1 to a PED 14 while not changing or only slightly changing the thickness, look, and feel of the PED 14, the optical zoom lens device 1 according to the present invention is positioned surprisingly parallel to one side, for example, the top, bottom, left, and right sides, or even the back of the PED 14. When the optical zoom lens device 1 is needed to shoot a video or a still photo of an object(s), optical zoom lens device 1 is mechanically or electronically turned to aim the object(s). The pivot 4 that supports the optical zoom lens device 1 can be anywhere between the optical zoom lens device 1 and the side of the PED 14. Electrical wires or connections 22, including via induction, may be integrated together with the pivot 4 or may be separate as an independent connection between the optical zoom lens device 1 and the PED 14. The electrical wires or connection 22 transfer data and operation signals to control the movement of the optical zoom lens device 1, to provide needed power for the movement of the optical zoom lens device 1 including extending or retracting to zoom and focus on an object and pivoting left, right, up and down for example, and to convert light to video and image signals and to transfer the video and image signals to the phone. The controls, for example, codes or orders, may be from the software running on the PED 14, including specialized programs or apps, or from the existing buttons on the PEDs 14 or control buttons on the optical zoom lens device 1 (not shown).

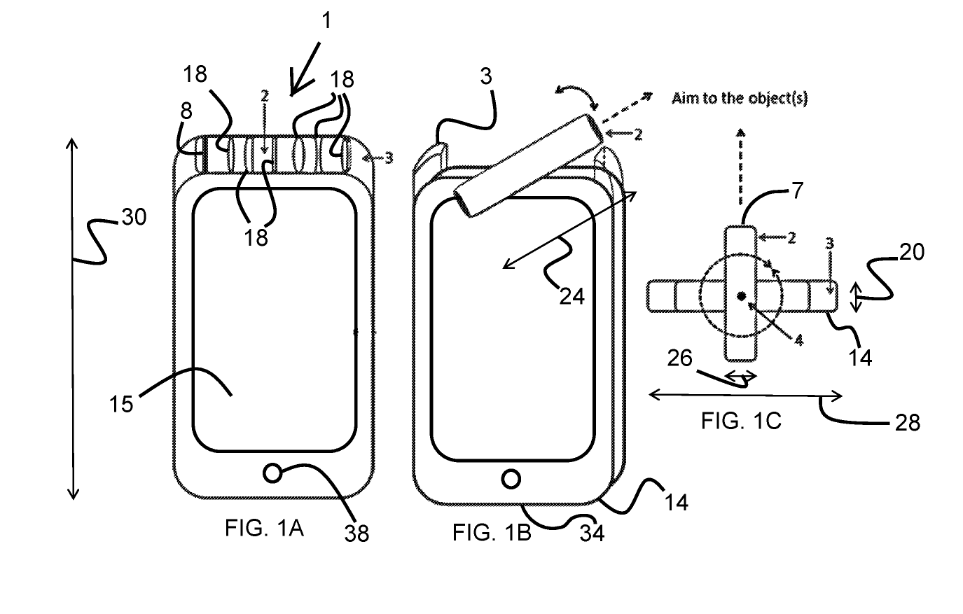

FIGS. 1A-1C schematically illustrates a basic design and use of the optical zoom lens device 1 according to the present invention. The optical zoom lens device 1 comprises an encasement 2, a lens 18, a light sensor 8, and a pivot 4. The lens 18 may be a single lens 18, but preferably includes a plurality of lens groups, the lenses 18 in a group moving substantially together in relation to lenses 18 in other groups. Six lenses 18 are shown encased in the encasement 2 in the various Figs, though other numbers and arrangements of lenses 18 and lens groups are within the scope of the invention. This is a first configuration of a structure of a directly integrated optical zoom lens device 1 into a smartphone type PED 14. In FIGS. 1A and 1B the front or screen 15 side of the phone is toward upward and out of the page. The back side 17, or the side normally without a larger screen 15, is facing down into the page. To use the optical zoom lens device 1, the preferably cylindrical shaped encasement 2 is simply mechanically or electronically turned and aimed to a desired object(s), as shown in FIG. 1B. An app or other program would preferably be initiated at this point or before the encasement 2 was initially turned (moved from the position in FIG. 1A to the position in FIG. 1B). The optical zoom lens device 1 may be focused manually or automatically. When the optical zoom lens device 1 zooms in or out, the length 24 of the encasement 2 may also change. The contour of the phone 14 is provided with an enclosure 3 to wrap the optical zoom lens device 1 for a smooth PED 14 profile, to protect the lens 18 of the optical zoom lens device 1, and to provide a sleek look and feel to the phone 14. The thickness or diameter 26 of the encasement 2 is preferably equal to or less than the thickness 20 of the PED 14, so the optical zoom lens device 1 would be less likely to stick out of the PED 14 and catch on items as the PED 14 is moved from one location to another (e.g., a pocket or purse). The encasement 2 may also have a square or substantially rectangular cross section so as to be substantially flush with the width 28 or height 30 of the PED 14 when the encasement 2 is in the closed recessed or docked position (see FIG. 1). The enclosure 3 can also house some phone parts. Gears and mechanism for optionally powered movement of the encasement 2 are not shown for clarity of the picture.

A connecting pivot 4 between the encasement 2 and the phone 14 supports and connects the encasement 2 and the PED 14. Usually one pivot 4 is enough to support the optical zoom lens device 1, but more than one pivot 4 is also possible. Electrical wires 22 may be hidden inside the pivot 4 or through a separated connection.

FIG. 1B shows the optical zoom lens device 1 connected to the phone with a pivot 4 in the middle of the axial length 24 of the encasement 2 and the middle of the top of the phone 14. The pivot 4 can be anywhere between the encasement 2 and the phone; for example, the pivot 4 can also be placed to the side of the phone and/or one end of the encasement 2. The different locations have different advantages and disadvantages. The preferable position of the pivot 4 is, as shown, in the mid-point of the axial length 24 of the encasement 2. This location minimizes torque on the connection if the optical zoom lens device 1 is accidentally knocked or bent when deployed. However, other non-mid-point locations are also acceptable. The non-mid-point or off-centered connection locations would benefit by having different attachment locations available, and also by projecting only or primarily forward (or whatever direction the encasement 2 is pointing in) when deployed so that the direction of filming is readily evident.

FIG. 1c shows a top-view of FIG. 1b. Through the pivot 4, the encasement 2 can be turned in any angle, so the user does not need to turn the phone 14, but simply turning the encasement 2 to shoot videos and photos. The pivot 4 preferably has a number of detent locations, providing that number of stable rest positions along the rotation of the encasement 2 around the pivot 4 circumference. The plurality of detent locations are preferably evenly spaced, and are preferably located between 90 degrees and 10 degrees apart, more preferably between 60 and 15 degrees apart, and most preferably between 40 and 20 degrees apart or, in an additional embodiment, are substantially 30 degrees apart. This ability to easily turn the encasement 2 to aim the lens 18 at the object simplifies the process of filming, because when the phone 14 itself must be turned, the user may also need to turn his/her head to look the screen 15. When the encasement 2 is required to be parallel to the top of the phone (that is, the lens 18 aims right or left when the user holds the phone towards him/her), the pivot 4 may telescope out or otherwise pop up so that the enclosure 3, if present, does not block the view of the lens 18. The encasement 2 of the optical zoom lens device 1 of with the mid-point pivot 4 design can be rested in any one of the two positions: with the light aperture 7 of the encasement 2 to the right or left.

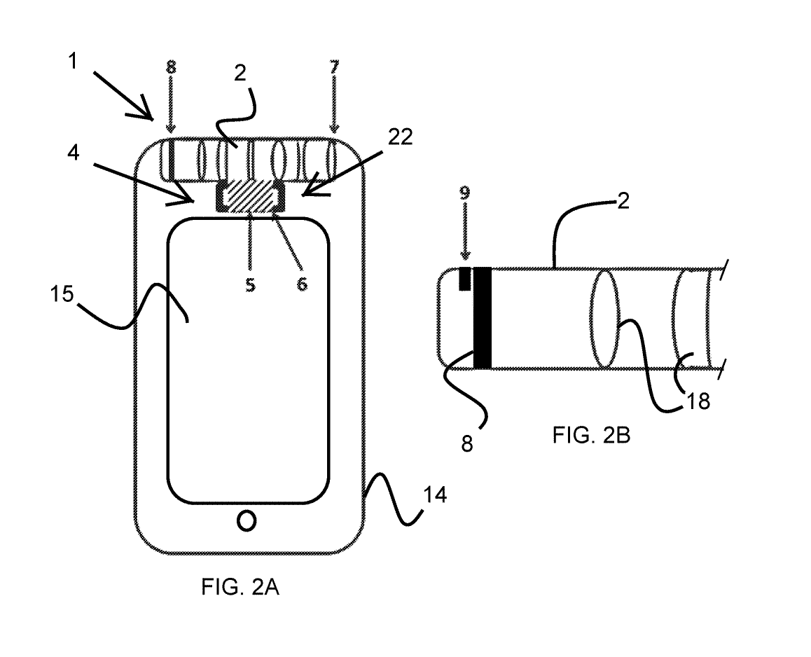

FIG. 2a shows one example of the pivot 4 structure. An inner cylinder 5 connects to the encasement 2 and the outer hollow cylinder 6 holds the inner cylinder 5, so that the encasement 2 is connected to the phone and the encasement 2 can be turned in any angle, such that the lens 18 in the encasement 2 can be directed at any angle. That is to say, a user can turn the lens 18 toward himself/herself to make self-portrait photos (including “selfies”) or videos. In case of self-portrait photos or videos, the user can take very high quality photos/videos using a high pixel lens 18 of the optical zoom lens device 1, in contrast to many PEDs 14 that use a relatively low resolution camera on the side of the PED 14 with the screen 15. Electrical wires 22 may be placed inside the pivot 4 inner cylinder 5, on the walls of inner cylinder 5, or through an independent connection to the phone 14. This figure also shows some basic structures of the optical zoom lens device 1 with the light aperture 7, lens 18, and the light sensor 8 such as a charge-coupled device (CCD) and other desired electronic circuits and mechanical parts.

The optical zoom lens device 1 may block the phone headset jack in a phone design according to current technology. In this case, an optional access port 9 may be disposed on the optical zoom lens device 1 as shown in FIG. 2B. The optional access port 9 may be in the form of a data port, phone headset jack, or power port. The phone jack or other access port 9 wires can be connected to the phone together with the wires 22 that transmit electrical power, audio and/or video data, and instructions.

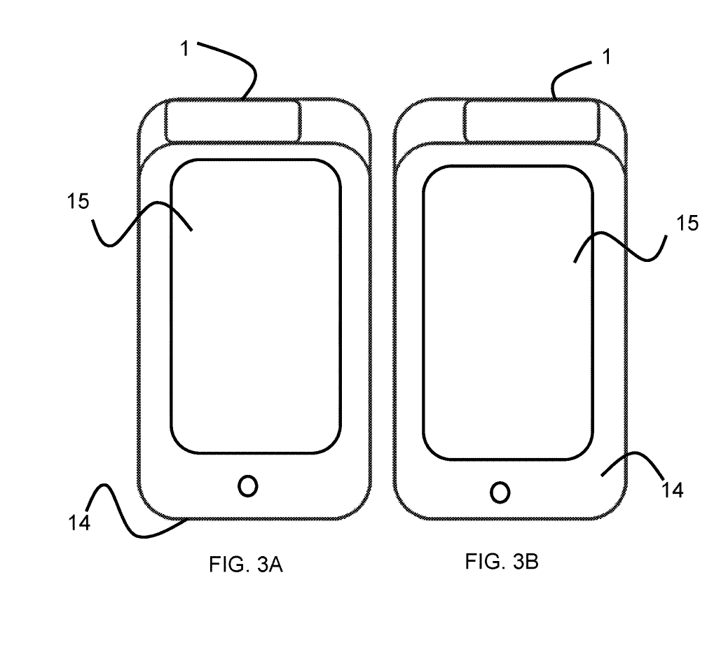

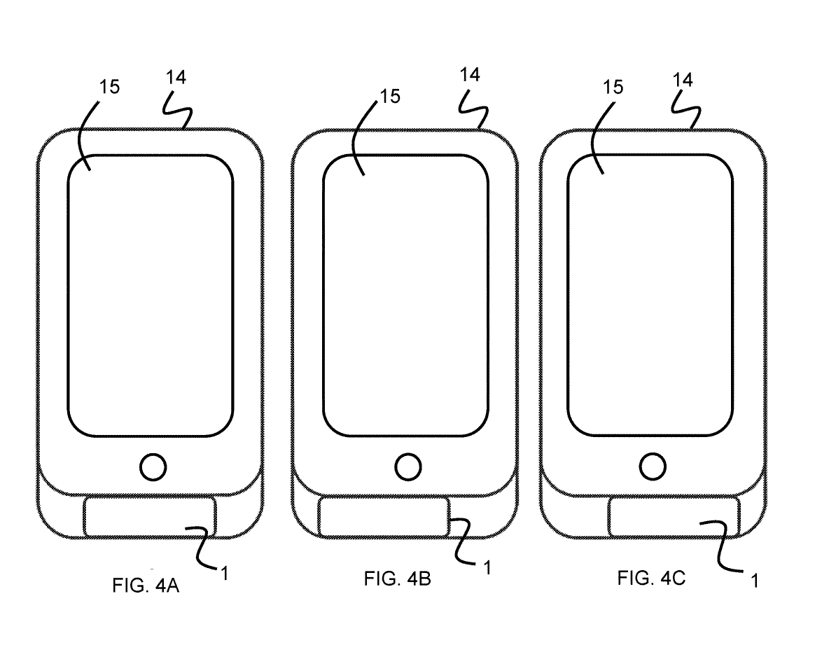

If the length 24 of the encasement 2 is shorter than the width 28 of the phone 14, the optical zoom lens device 1 can be located at the center (as shown in FIG. 1A), the left (FIG. 3A), or the right (FIG. 3B) of the top of the phone. The optical zoom lens device 1 can also be placed on other sides of the PEDs 14. FIGS. 4A-4C show a second set of structure configurations in which the optical zoom lens device 1 is placed to the bottom of a phone 14. In FIG. 4A, a central location is shown. If the length 24 of the encasement 2 is shorter than the width 28 of the phone, the optical zoom lens device 1 can be located at a position skewed to the left FIG. 4B or skewed to the right FIG. 4C of the bottom, or any other positions along the bottom.

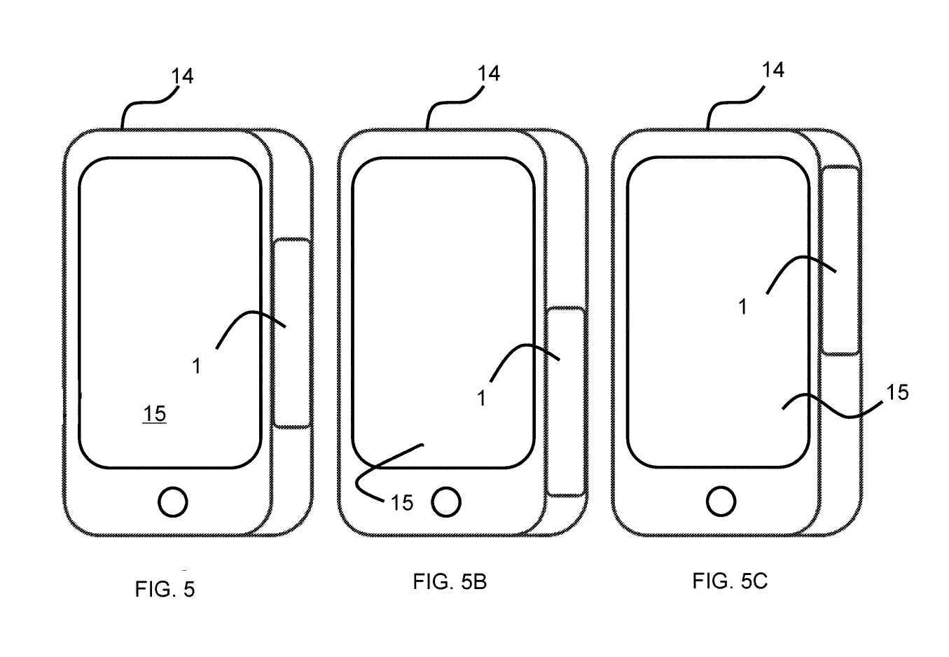

FIGS. 5A-5C show that the optical zoom lens device 1 may be located on the side (right or left) of a phone. In FIG. 5A, a central location is shown. If the length 24 of the encasement 2 is shorter than the height 30 of the phone 14, the optical zoom lens device 1 can be located at a position skewed to the lower FIG. 5B or upper FIG. 5C portions of the side of the phone 14, or any other positions along the side of the phone 14.

Similarly to FIG. 2, the pivot 4 used for these positions can be located anywhere along the length of the encasement 2 from the front (light aperture 7) to the rear, and anywhere along the phone 14 to hold the optical zoom lens device 1. Again, electrical wires 22 may be hidden inside the pivot 4 or be external to the pivot 4 or use some other means of data and power transmission—such as induction or wireless transmission, for example.

The adjacent enclosure 3 areas shown in FIGS. 1A-5C, are preferably not used just as an enclosure for the encasement 2, but are part of the phone 14 structure and are preferably filled with circuitry, electronics, and other PED 14 elements. FIG. 2A shows the enclosures 3 as continuous pieces of the phone 14, and shows the optical zoom lens device 1 with an integrated pivot 4 component.

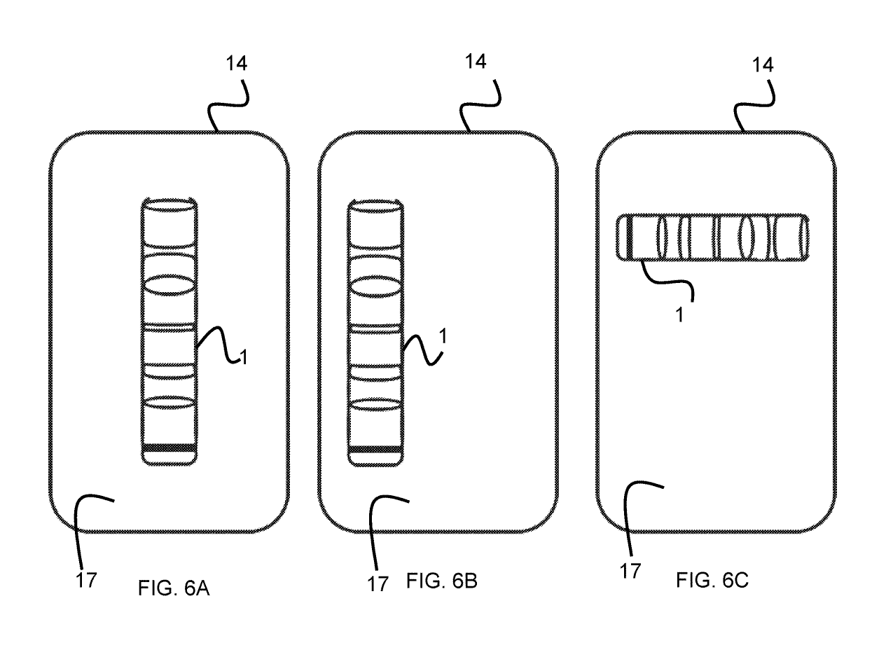

The optical zoom lens device 1 can also be placed in any position of the back 17 of the PEDs 14. FIGS. 6A-6C show a selection of possible positions of placing the optical zoom lens device 1 along the back 17 of a PED 14. This back side 17 arrangement has the benefit of much greater variety of locations than the front of the PED 14, as the screen 15 limits potential placement locations on the front side. FIG. 6A shows the optical zoom lens device 1 oriented vertically in the center of the back 17. FIG. 6B shows the optical zoom lens device 1 oriented vertically toward the left of the back 17. FIG. 6C shows the optical zoom lens device 1 oriented horizontally toward the top of the back 17. As described above, other positions are also possible, such as right, center parallel, lower part, and diagonal, just for example.

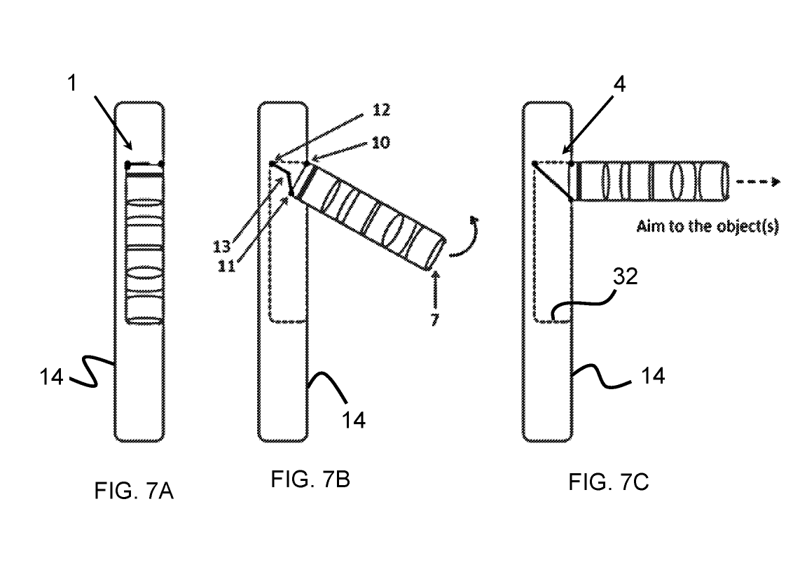

For different configurations of the optical zoom lens device 1 with respect to the PED 14, especially when located along the back 17 of the PED 14, hinges 10, 11, 12 and levels 13 present a further embodiment of the pivot 4 that also holds the encasement 2 at a substantially orthogonal position to a plane defined by the back surface 17 of the PED 14. FIGS. 7A-7C show one such a design when the optical zoom lens device 1 is integrated into the back 17 of a phone 14. FIG. 7A is the situation where the optical zoom lens device 1 is not in use. This recessed or docked position, shown in FIG. 7A is preferably a stable, stationary/resilient position in an encasement recess 32 in the back 17 of the phone 14 that the encasement 2 portion of the optical zoom lens device 1 snaps into and out of FIG. 7b shows the encasement 2 and lens 18 after moving from the docked position and moving up toward the fully deployed position. As the encasement 2 moves up, three hinges 10, 11, 12 are seen. A first hinge 10 is on the upper part of the end of the encasement 2, connecting the upper end portion of the encasement 2 to the phone body. A second hinge 11 is on the lower part of the end of the encasement 2, connecting the encasement 2 to the folding levels 13. A third hinge 12 is on the upper part of the encasement 32 recess, and connects the folding levels 13 and the phone 14 body. FIG. 7C shows the encasement 2 in the fully deployed position, where the encasement 2 is orthogonal to the phone back 17. In this configuration, the electrical wires 22 may be placed inside one of the hinges 10, 11, 12 or through a separate, adjacent or removed connection to the phone 14 (not shown).

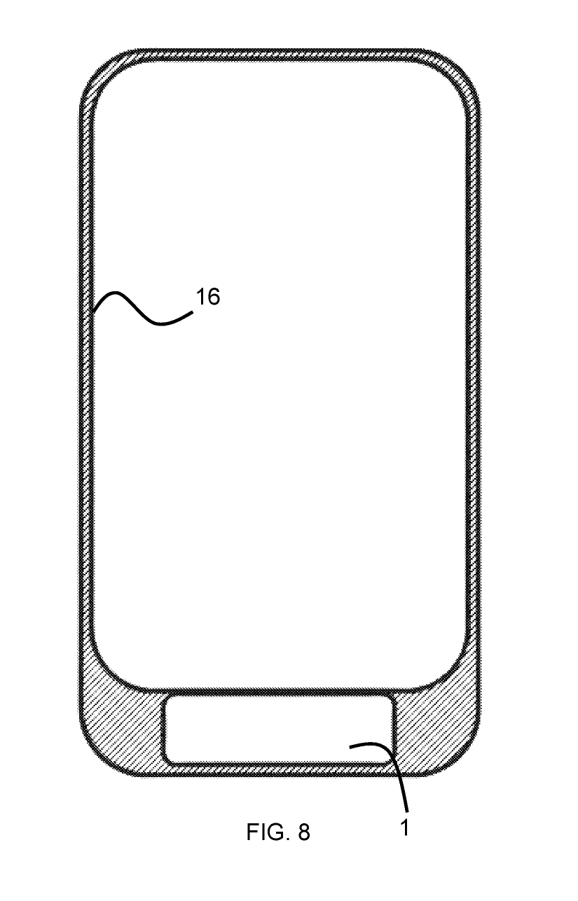

In further embodiments the optical zoom lens device 1 may be indirectly integrated into the PED 14. In a first indirect integration embodiment, the optical zoom lens device 1 may be integrated into a PED case casing 16, which then mounts onto a PED 14. FIG. 8 shows an example that the optical zoom lens device 1 as a part of a casing 16 connected to phones. The casing 16 can be protective, ornamental, or otherwise functional or decorative. The optical zoom lens device 1 can be engineered on the top, bottom, side, or back of the casing 16, and the pivot 4, including a hinge/level pivot 4, connections can be anywhere to connect and support the encasement 2. The wires 22 to control and power the encasement 2 and to transfer video/photo signals can be embedded into the pivot 4 or through a separate connection. In this embodiment, the optical zoom lens device 1 can be engineered into plain covers/cases 16, underwater cases 16, external battery power cases 16, selfie sticks 16, or other structures 16 that protect/hold/support the PEDs 14.

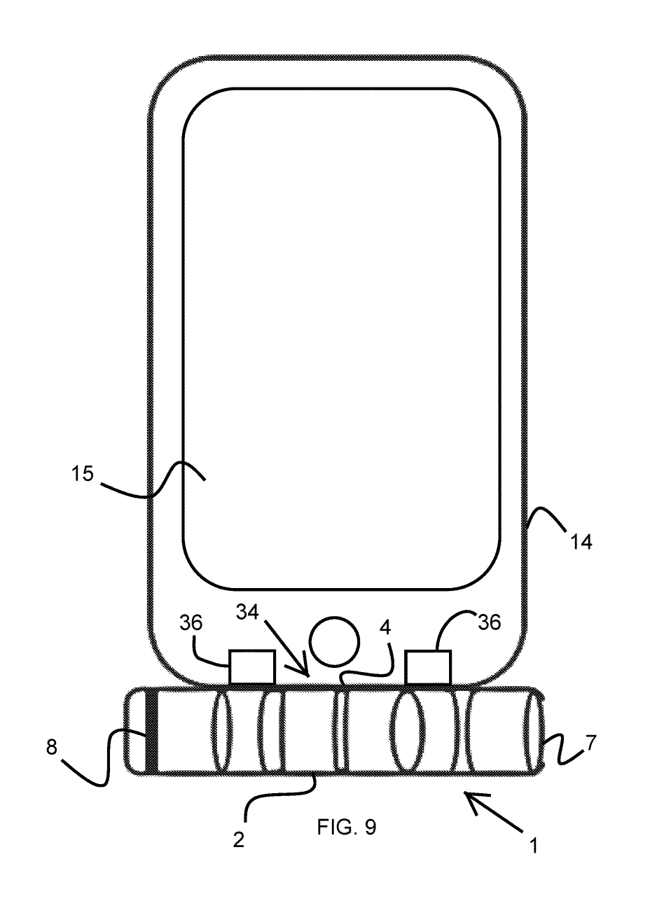

In a second indirect integration embodiment, the optical zoom lens device 1 may be a single after-market stand-alone unit 1. The stand-alone unit 1, sold as an accessory for example, can be connected to the PED 14 using the PED's 14 data connector 34. As shown in FIG. 9, the data connector 34 can also act as a supporting pivot 4 for the lens 18. Most smartphones 14 have multi-function power/data interface/connector 34 on the bottom of the phones. If a stand-alone unit optical zoom lens device 1 mounted to the phone 14 blocks/occupies this interface 34, an extra interface, similar to the access port 9 shown in FIG. 2B, may be provided on the encasement 2 or pivot 4 so that the users can continue to utilize the interface 34 functionality without having to remove the stand-alone unit 1. An additional mechanical connector or clasp 36, proximate to the pivot 4, may be provided to help secure the stand-alone unit optical zoom lens device 1 to the PED 14.

For all the configurations mentioned in this invention, it is anticipated that according to some embodiments the encasement 2 direction, in other words where the light aperture 7 is pointing to, may be substantially any direction, regardless of whether the optical zoom lens device 1 is directly or indirectly integrated in the PEDs 14 or their cover/cases. A ball and socket type pivot 4 and other free direction pivots 4, aid in such functionality.

The lens 18 itself or encasement 2 can be changed with the various disclosed embodiments. For example, a 1-10× zoom lens 18 may be changed to a 20-50× zoom lens 18 or a 100× prime (fixed) lens 18 for special video/photo shooting purposes. Another example is a PED 14 or its case 16 may have more than one zoom lens 18. One example is to have two optical zoom lenses 18 (both can be on one side or different sides): one for lower zoom, another for higher zoom. The two lenses 18 may be the same so that the users can take 3D videos/photos. The interchanging capability for the stand-alone unit optical zoom lens device 1 shown in FIG. 9 is also envisioned.

While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

Wherefore we claim:

1. An optical zoom lens device for use with a portable electronic device comprising:
an encasement including a lens and a light sensor; and
a pivot for connecting the encasement to the portable electronic device.

2. The optical zoom lens device of claim 1 wherein a length between the lens and the light sensor is adjustable.

3. The optical zoom lens device of claim 1 wherein the encasement is rotatable about the pivot.

4. The optical zoom lens device of claim 1 further comprising electronic connections adjacent to the pivot for one of powering movement of a direction of aim of the lens, a change of zoom, a change of focus, and some combination thereof, and transmitting one of audio, visual, and control signals one of to and from the optical zoom lens device.

5. The optical zoom lens device of claim 1 further comprising one of a microphone, a speaker, a light, and a light sensor.

6. The optical zoom lens device of claim 1 further comprising an electronic access port located on one of the encasement and the pivot. The optical zoom lens device of claim 6 wherein the electronic access port is one of a power connection, a data connection, an audio connection, a video connection, an audio and video connection, and some combination thereof

8. A portable electronic device comprising:
a body;
a screen; and
an optical zoom lens device,
where the optical zoom lens device includes
an encasement including a lens and a light sensor, and
a pivot for connecting the encasement to the portable electronic device.

9. The portable electronic device of claim 8 wherein the body defines a recess or opening where the encasement rests in a docked position, and from which the encasement pivots in a deployed position.

10. The portable electronic device of claim 9 wherein when the encasement is in the docked position, the encasement is substantially flush with a thickness of the body.

11. The portable electronic device of claim 8 wherein the optical zoom lens device is directly integrated into the portable electronic device.

12. The portable electronic device of claim 8 wherein the optical zoom lens device is aligned along a perimeter of the body.

13. The portable electronic device of claim 8 wherein the optical zoom lens device is arranged on a side of the body opposite to the screen.

14. The portable electronic device of claim 8 wherein a cross section of the encasement is substantially equal to a thickness of the body.

15. The portable electronic device of claim 8 wherein a length of the encasement is substantially equal to one of a height and width of the body.

16. The portable electronic device of claim 8 wherein the body further comprises enclosures that bound one or both axial ends of the encasement when the encasement is in a docked position.

17. The portable electronic device of claim 8 wherein the pivot further comprises a plurality of hinges and a folding level.

18. A portable electronic device case comprising
a casing; and
an optical zoom lens device located in the caseing;,
where the optical zoom lens device includes
an encasement including a lens and a light sensor, and
a pivot for connecting the encasement to the portable electronic device.

19. The portable electronic device case of claim 18 further comprising an electronic connection on the pivot to electronically connect the optical zoom lens device to a portable electronic device, and an electronic access port located on one of the encasement and the pivot.

20. The portable electronic device case of claim 18 wherein the electronic access port is one of a power connection, a data connection, an audio connection, a video connection, an audio and video connection, and some combination thereof.
